(19) United States
(12) Patent Application Publication
(10) Pub. No.: US 2006/0179357 A1
(43) Pub. Date: Aug. 10, 2006

(54) Method and arrangement for tracking executed operations when using a computer program

(76) Inventor: Anette Bergstrom, Solna (SE)

Correspondence Address: POTOMAC PATENT GROUP, PLLC, P. O. BOX 270, FREDERICKSBURG, VA, 22404, US

(21) Appl. No.: 10/568,383

(22) PCT Filed: Aug. 13, 2004
(86) PCT No.: PCT/SE04/01194

§ 371 Date: Mar. 16, 2006

(30) Foreign Application Priority Data
Aug. 15, 2003 (SE) 0302227-4

(51) Int. Cl. G06F 11/00

(52) U.S. Cl. 714/45

(57) ABSTRACT

A method and arrangement for tracking individual operations executed in a specific computer program, where inputs made by the user are detected. Each detected input is compared with a set of operations defined in advance, which have been stored in an operation database. If a detected input matches some predefined operation in the comparison, that operation is registered as an executed activity in an activity database. The procedure is repeated for a number of inputs as executed during a recording session, wherein an activity list of performed operations is created in the activity database. This list can then be retrieved, after the recording session in order to track individual operations. Thereby, a course of events can be analyzed in detail after using the computer program, e.g. with the purpose of discovering erroneous operations.

### FIELD OF THE INVENTION

The present invention is related to a method and an arrangement for tracking operations or activities which have been performed during the use of a computer program. In particular, it is related to a solution for enabling the tracking of any erroneous inputs and/or commands made by a user.

### BACKGROUND OF THE INVENTION

When working with various computer programs and computer applications, it is not uncommon that a program suddenly gets locked or does not operate in a way that is desired or expected. This may be the result of a user having, more or less unconsciously, performed some erroneous or unsuitable operation in the program, or that there is some error therein, a so-called “bug”. Such operations are performed when activating various functions, pressing keys, clicking a mouse, etc., which when executed separately or in combination may result in locking or erroneous function of the program or programs being used. In this description, the term “operation” will be used to denote any action that a user may perform in a computer program and which in some way affects/activates the program. Thus, an executed operation is the result of one or more inputs, such as keystrokes, mouse clicking's, or speech in the case of speech controlled programs.

For example, when using computer programs for word processing, calculation sheets or databases, entirely unexpected situations may sometimes occur, e.g. loss of data, a change of screen appearance, or locking of the program by not responding to any inputs whatsoever. In order to take necessary actions for correcting the “behavior” of the program, it is often a great help if the previous operations executed so far are known and can be analysed. Thus, if an earlier executed erroneous operation can be tracked, it is easier to understand what has happened and why the current situation has appeared.

During data education for specific computer programs, it is customary for a teacher to help and instruct trainees practising to use the program. Then, it is almost unavoidable that situations as mentioned above sooner or later occur. The teacher often asks the trainee what he/she has done in the program before, e.g., an error occurred. Frequently, the trainee does not remember all the operations that have been executed, or alternatively, some operations have been executed entirely unintentionally or unconsciously. For example, the error may arise from some input that has been made a fairly long time ago, or from the trainee simply having accidentally depressed a key without noticing. In that case, the teacher must typically spend much time on finding out what has happened and what is needed to remedy the situation. Unnecessary discussions may also arise regarding what the trainee has done and not done. Furthermore, it is desirable that the trainee is informed about the mistake(s) having been made, in order to be able to avoid them in the future and to learn how the program works.

The above-mentioned problems and needs may exist also in many other situations, such as in enterprises or organizations where computer users can approach a person or department providing information and support regarding issues on data programs, so-called “data support”, or for individual users wanting to be able to make quick error searches or the like. It may also be useful to be able to track previously made operations when testing and evaluating a new or modified data program, in order to find any imperfections and erroneous programming.

US 2001/0003172 A1 discloses a system where the different computer activities of a user are registered to create a log file intended to be used for recording the user's work within specific projects, etc. However, this US document does not describe the tracking of individual operations being executed when using a specific computer program, which is neither desirable to attain nor discussed in the solution of the above-mentioned document.

US 6115680 A discloses a solution for collecting information and statistics on how a group of users use their computer resources. Different events of a generic nature, such as mouse clicking's and keyboard inputs, are logged in a list where executed events are identified by comparison with predefined events. However, these predefined events are not associated with any specific computer program. Further, according to this document, there is no object to monitor a specific computer program during a recording session as the program is used by a user.

Hence, there is generally a need for a simple way of being able to observe and identify all the individual operations being executed during the use of specific computer programs, in order to e.g. discover any erroneous inputs and/or commands made by a user.

### SUMMARY OF THE INVENTION

It is an object of the present invention to obtain a solution enabling the tracking of executed individual operations when using specific computer programs. This object and others are obtained by a method of tracking individual operations executed by a user in a specific monitored computer program during use thereof. When at least one input made by the user is detected, the detected input is compared with a set of operations defined in advance. An operation corresponding to the input is registered as an executed activity, if the input matches any predefined operation as the comparison is made.

According to the invented method, the set of operations defined in advance are operations that in some way can affect the monitored computer program, which set has been created by logging specific messages being generated by the computer program in response to inputs affecting the program, each predefined operation corresponding to one or more specific messages generated by the program. The above procedure of detecting, comparing and registering an input is repeated for a number of inputs and corresponding operations as executed in a recording session during the time period of using the monitored computer program, such that an activity list of performed operations is created for the recording session that can be retrieved afterwards in order to track individual operations in the monitored computer program.

An input may be detected by monitoring a corresponding message being generated by the computer program in response to the input.

The set of predefined operations may be stored in an operation database. This set may include operations that are generic independent of which program is used, or specific to the program. Furthermore, the set of predefined operations may have been created by executing a basic set of operations that a user can be expected to perform in the program, in order to build up said operation database.

The registration of an executed operation may include retrieving a predefined term for the operation, which term may be stored in said activity list.

Predefined presentation rules may be applied to executed operations before storing them in the activity list, the presentation rules determining how the information on executed operations is to be processed for later presentation. These presentation rules may further have been stored in a rule database. The presentation rules may also comprise a filter function such that only certain types of operations are registered, while other ones are ignored.

The present invention further encompasses an arrangement for tracking individual operations executed by a user in a specific monitored computer program during use thereof. This arrangement comprises means for detecting inputs made by a user and for comparing them with a set of operations defined in advance, and means for registering operations as executed activities during a recording session for the inputs matching any predefined operation.

The invented arrangement further comprises means for creating the set of operations defined in advance, which in some way can affect the monitored computer program, by logging specific messages being generated by the computer program in response to inputs affecting the computer program, where each predefined operation corresponds to one or more specific messages generated by the program. Furthermore, there are means for creating an activity list for a recording session with performed operations, by the detection of a number of inputs and the registration of corresponding operations as executed during the time period of using the monitored computer program, such that said list can be retrieved after the recording session in order to track individual operations in the monitored computer program.

The present solution is very effective by the focused matching with exclusively “relevant” predefined operations, while disregarding those that do not affect the program. Furthermore, the solution allows for that certain input combinations being significant for the program may represent a predefined operation affecting the program in a certain predictable manner.

### BRIEF DESCRIPTION OF THE DRAWINGS

The present invention is described in more detail below by means of preferred exemplary embodiments, and with reference to the accompanying drawings:

FIG. 1 is a schematic block diagram of a system architecture of an administrative tool that can be used for the present invention,

FIG. 2 is a schematic block diagram of a system architecture of a tracking program that can be used for the present invention, and

FIG. 3 is a flow chart of a working procedure of determining previously executed operations in a specific computer program, according to the present invention.

### DETAILED DESCRIPTION OF PREFERRED EMBODIMENTS

The present invention is intended to accomplish fast and effective tracking of previously executed operations in a computer program, e.g. in order to facilitate the discovery of any erroneous inputs or commands as executed by a user, or any existing erroneous programming or imperfections in the program.

Briefly described, the invention involves the registration and storing, i.e. “recording”, of operations executed by a user during the time period of using a monitored computer program. To this end, a specifically designed program is used, which will be called “the tracking program” hereafter for the sake of simplicity, running in parallel with the computer program and monitoring it with respect to the activities of the user.

During the recording of the activities of the user, executed operations are identified by detecting and comparing each input or combination of inputs with a set of operations defined in beforehand, which in some way can have an effect on the program. Thus, these predefined operations are stored as available for the tracking program. Such predefined operations may on one hand be generic independent of which program is used, such as the depressing of physical keys on a keyboard, or may on the other hand be specific for each program, such as the selection of functions available in the program, e.g. by clicking icons, menus, buttons, etc. being displayed on the screen. In many programs, certain commands may also be executed by depressing one or more keys, such as, e.g., Ctrl+S for saving documents, or functional keys F1-F12.

Thus, the tracking program comprises a function of detecting the inputs of the user and comparing them with the predefined operations. If a detected input matches such a predefined operation, it is registered as an executed activity. Thus, the tracking program is configured to gradually register any operations identified in this manner as they are executed, and to save them in an activity list. Preferably, this list may also contain information on the time of execution of the operations.

At a later moment, when the recording session has been terminated, the activity list with saved operations can be retrieved and reviewed, in order to analyse the course of events and to track individual operations, e.g. an erroneous input. This may be of interest if the program has been locked or does not work properly, or if the skill of the user is to be evaluated, e.g. after an executed test. Within the scope of the invention, the activity list can be designed in different ways. For example, the registered operations may be sorted chronologically in the list, or in any other way. Further, The operations may be classified and sorted into different groups, e.g. depending on the type of operation, which may facilitate the search and analysis in some situations.

Preferably, the operations in the list are designated by predetermined suitable terms in plain language, in order to be easily identified and understood. These operation terms are preferably determined during the predefinition of the operations according to the above. Such an operation term may optionally constitute a concise name, or a longer more informative disclosure. Furthermore, different filter functions may be used such that only certain types of operations are registered, while other ones are ignored. For example, character inputs can be filtered out in the case where these do not affect the program in a certain situation.

The tracking program may be configured to be capable of monitoring plural different computer programs, by containing a file for each program having predefined operations and filter functions, if any. It is also possible to install a new such file when a new program is to be added for surveillance, or when a monitored program has been modified.

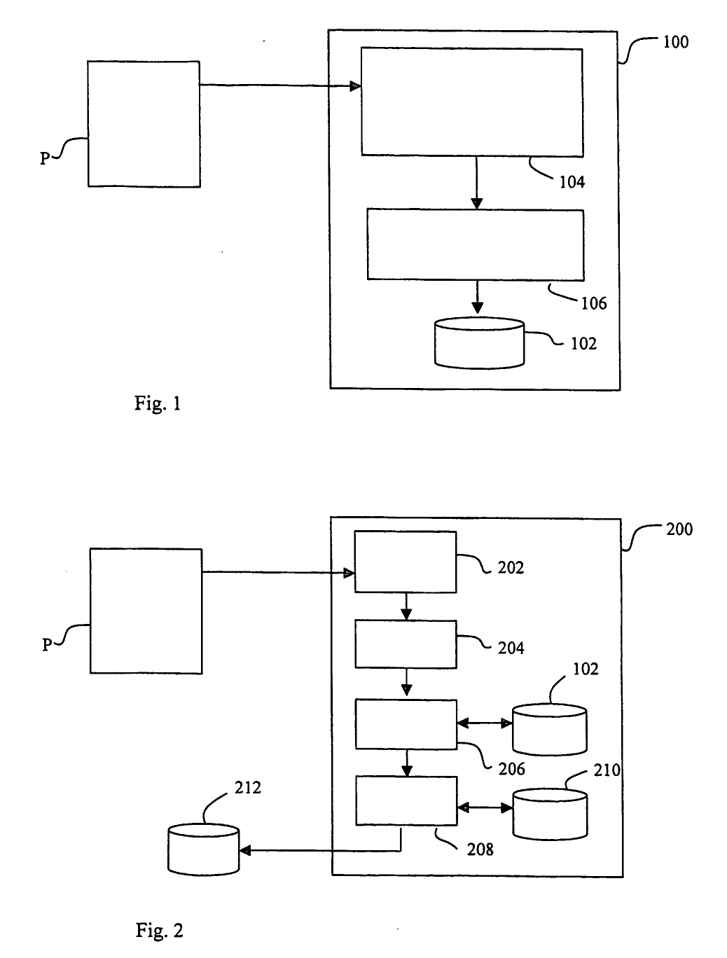

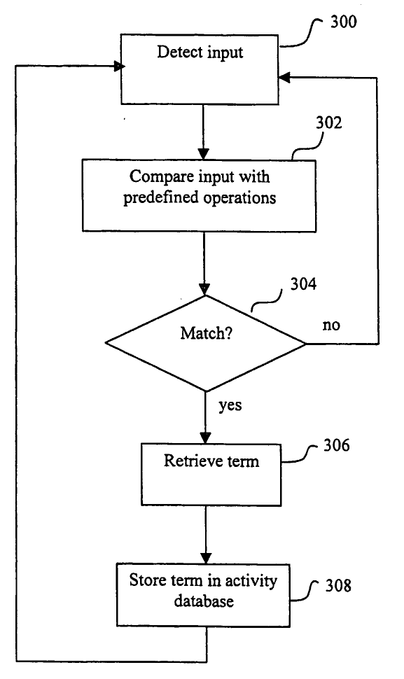

With reference to FIGS. 1 and 2, an exemplary suitable system architecture that can be used for implementing the present invention will now be described. Basically, the system architecture may be divided into an administrative tool and the above-mentioned tracking program, wherein the administrative tool is used mainly to define and store the operations which can be executed when using a monitored program.

FIG. 1 discloses a logical block diagram of an administrative tool 100 that can be used, e.g., by a system supplier for building up an operation database 102 with predefined operations for a specific computer program P to be monitored later. Generally speaking, when different inputs are made in the program P, different messages are generated by the program in a known manner, which are sent to other programs or applications in the computer resulting in different events, such as a new appearance on the screen. Thus, each input affecting the program corresponds to a specific message. In practice, such generated messages may be monitored, e.g. by means of a known function called “SetWindowsHookEx( )”, which is an integral part of the well-known operative system Windows, which can be utilised in this concept.

The administrative tool 100 comprises a logging function 104 configured to monitor and intercept such messages being generated by the program P in response to inputs, and then interpret them. In practice, a basic set of operations that a user can be expected to perform are executed systematically in the program P, wherein the logging function 104 logs messages that are intercepted in connection with each operation. These are then saved as different patterns in the operation database 102, where each predefined operation corresponds to one or more specific generated messages.

The administrative tool 100 further comprises a designation function 106, by means of which the saved operations can be given names. The designation function 106 is controlled by means of a user interface, not shown, in which a system administrator or the like can manually define any optional term, such as a name or a description, for each executed operation. This term is intended to be easily identified and understood by a future user of the tracking program. Finally, the registered operations are saved together with the corresponding term in the operation database 102. Alternatively, the operations may be saved as simple codes in the operation database 102, while the defined associated terms are saved in a separate rule database stating how the information is to be presented to the end-user, which will be described below.

Basically, the above-described procedure is performed for all conceivable and/or interesting operations for the specific computer program P to build up the operation database 102, which thus can be regarded as a kind of calibration procedure. When the operation database 102 is complete, the program can be monitored by the recording of identified operations by means of the tracking program, which is described in more detail below.

FIG. 2 illustrates a logical block diagram of a suitable architecture of the tracking program 200, which is intended to be executed in connection with the use and monitoring of the computer program P. The tracking program 200 comprises a series of logic functions being executed in proper order according to the below. A logging function 202 is adapted to intercept different messages being generated in the program P as a user makes various inputs, in a corresponding manner as to what has been described in connection with FIG. 1. Thus, this logging function 202 may be of the same type as the logging function 104 that was used in the administrative tool 100, e.g. the function “SetWindowsHookEx( )” mentioned above.

Logged inputs are then processed by an analysing function 204, where redundant information, or “noise”, can be screened out. This may be messages generated in connection with inputs being regarded as of no interest, e.g. a so-called “focus function” meaning that a focus can be shifted between different menus or buttons when highlighted on the screen by the pressing of arrow keys or the equivalent.

Thereafter, the received information is supplied to a matching function 206 which compares executed inputs with the predefined operations being stored in the operation database 102 according to FIG. 1. Then, if an operation is identified matching the executed input, this operation can be further processed by a presentation function 208, which is adapted to apply predefined presentation rules to the identified operations. These presentation rules are stored in a rule database 210. Such rules may be a linguistic check-up and the application of special preferences of the end-user regarding how the information is to be presented, etc. The presentation rules may also include one or more filter functions such that only certain types of operations are registered, while other ones are ignored. Further, the terms of the operations may be stored in the rule database 210, as mentioned above.

Thus, the presentation function 208 is intended to save the information in a comprehensive format corresponding to the preferences of the end-user. Within the scope of this invention, plural different users may define their own profiles which are saved in this rule database 210. Depending on which user is logged-in for a certain recording session, the rules associated with this user are applied.

Finally, the processed information on executed operations is saved in an activity database 212 which can be consulted later to track individual operations, as described above. The tracking program 200 is also provided with a suitable user interface, not shown, that can be used for reviewing operations previously executed during a recording session which has now been terminated. This tracking interface may suitably display a catalogue of the computer programs that can be monitored by means of the tracking program, functional buttons for controlling the recording session, such as start, stop and pause, the status of one or more ongoing or terminated recording sessions, detailed activity lists of executed operations for each session, dialog boxes for login and the definition of user profiles, just to mention a few examples.

FIG. 3 illustrates a simplified flow chart of the procedure executed by the tracking program to register executed operations after the recording function has been activated. In a first step 300, an input made by a user is detected. Within the scope of this invention, such an input may constitute, e.g., depressing a button, clicking a mouse or making a speech command, executed separately or in combination. This input is then compared, in a step 302, with the predefined operations being stored in the operation database 102. In a next step 304, it is determined whether the input matches any of the predefined operations. If not being the case, the procedure returns to step 300 in order to investigate a new input. However, if a matching operation is identified in step 304, a corresponding term is retrieved for this operation, in a next step 306, either from the operation database 102 or from the rule database 210, depending on where it was stored during the above-described calibration procedure. Finally, this operation term is stored in the activity database 212, in a step 308, possibly after adaptation according to specifications in the rule database 210, as described above.

The present invention makes it possible to analyse the course of events in detail and in a simple and smooth manner, when using a specific monitored computer program. Thus, all individual operations are registered that have been identified as being executed during a recording session, based on inputs made by the user, and that have been defined in advance as being relevant to the monitored program. For example, this solution may be used to discover any erroneous inputs and/or commands, or to evaluate a new or modified program.

The invention is not limited to the embodiments described above, but is generally defined by the following claims.

1. A method of tracking individual operations executed by a user in a specific monitored computer program during use thereof, comprising the steps of:
A) detecting at least one input made by the user, B) comparing the detected input with a set of operations defined in advance, and C) registering an operation corresponding to the input as an executed activity, if the input matches any predefined operation as the comparing step B) is performed, wherein
the set of operations defined in advance are operations that in some way can affect the monitored computer program, which set has been created by logging specific messages being generated by the computer program in response to inputs affecting the program, each predefined operation corresponding to one or more specific messages generated by the program,
wherein steps A)-C) are repeated for a number of inputs and corresponding operations as executed in a recording session during the time period of using the monitored computer program, such that an activity list of performed operations is created for the recording session that can be retrieved afterwards in order to track individual operations in the monitored computer program.

2. A method according to claim 1, wherein an input is detected in step A) by monitoring a corresponding message being generated by the computer program in response to the input.

3. A method according to claim 1, wherein said set of predefined operations has been stored in an operation database.

4. A method according to claim 3, wherein said set includes operations that are generic independent of which program is used, or specific to the program.

5. A method according to claim 3, wherein said set of predefined operations has been created by executing a basic set of operations that a user can be expected to perform in the program, in order to build up said operation database.

6. A method according to claim 1, wherein the registration of an executed operation in step C) includes retrieving a predefined term for the operation, which term is stored in said activity list.

7. A method according to claim 1, wherein predefined presentation rules are applied to executed operations before storing them in said activity list, the presentation rules determining how the information on executed operations is to be processed for later presentation.

8. A method according to claim 7, wherein said presentation rules have been stored in a rule database.

9. A method according to claim 7, wherein said presentation rules comprises a filter function such that only certain types of operations are registered, while other ones are ignored.

10. An arrangement for tracking individual operations executed by a user in a specific monitored computer program during use thereof, comprising means for detecting inputs made by a user and for comparing them with a set of operations defined in advance, and means for registering operations as executed activities during a recording session for the inputs matching any predefined operation, comprising:
means for creating the set of operations defined in advance, which in some way can affect the monitored computer program, by logging specific messages being generated by the computer program in response to inputs affecting the computer program, where each predefined operation corresponds to one or more specific messages generated by the program, and
means for creating an activity list for a recording session with performed operations, by the detection of a number of inputs and the registration of corresponding operations as executed during the time period of using the monitored computer program, such that said list can be retrieved after the recording session in order to track individual operations in the monitored computer program.
